(19) United States
(12) Patent Application Publication
(10) Pub. No.: US 2006/0269142 A1
(43) Pub. Date: Nov. 30, 2006

(54) Apparatus and method for subtyping window elements in a document windowing system

(75) Inventors: Stuart A. Schweid, Pittsford, NY (US); Jeng-Nan Shiau, Webster, NY (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/139,781

(22) Filed: May 31, 2005

(51) Int. Cl. G06K 9/62

(52) U.S. Cl. 382/209

(57) ABSTRACT

Methods and apparatus may include assigning a subtype, from a sub-class of image types, to a pixel, the subtype indicating membership in a window and also indicating a more specialized sub-class of image types. Membership in the sub-class may specify downstream processing specific to the subtype and compatible with the downstream processing of other subtypes within the sub-class. Such methods and apparatus may allow individual pixels within a window to receive specialized downstream processing according to their subtype while preventing objectionable artifacts. Such artifacts may result from classifying neighboring pixels as image types calling for mutually incompatible downstream processing.

Cross-reference is made to co-pending, commonly assigned applications, including: U.S. application Ser. No. ______, filed ______, entitled “Apparatus and Method for Detecting White Areas Within Windows and Incorporating the Detected White Areas Into the Enclosing Window” to Metcalfe et al., and U.S. application Ser. No. ______, filed ______, entitled “Apparatus and Method for Auto Windowing Using Multiple White Thresholds” to Metcalfe et al., (Attorney Docket Nos. 123342 and 123343) which are incorporated herein by reference in their entirety.

### BACKGROUND

The present disclosure relates to methods and apparatus for segmenting a page of image data into one or more windows and for classifying the image data within each window as a particular type of image data. Specifically, the present disclosure relates to apparatus and methods for differentiating background from document content.

Image data is often stored in the form-of multiple scanlines, each scanline comprising multiple pixels. When processing such image data, it is helpful to know the type of image represented by the data. For instance, the image data may represent graphics, text, a halftone, continuous tone, or some other recognized image type. A page of image data may be all one type, or some combination of image types.

It is known in the art to separate the image data of a page into windows of similar image types. For instance, a page of image data may include a halftone picture with accompanying text describing the picture. It is further known to separate the page of image data into two or more windows, a first window including the halftone image, and a second window including the text. Processing of the page of image data may then be carried out by tailoring the processing of each area of the image to the type of image data being processed as indicated by the windows.

It is also known to separate a page of image data into windows and to classify and process the image data within the windows by making either one or two passes through the page of image data. Generally, images are presented to processing equipment and processed in a raster or other fashion such that at any given time, only a certain portion of the image data has been seen by the processing equipment, the remaining portion yet to be seen.

In a one pass system the image data is run through only once, whereas in a two pass system the image data is run through twice. The second pass does not begin until some time after the first pass has completed. A one pass method is generally quicker, but does not allow the use of “future” context to correct information that has already been generated. In a two pass method, information obtained for a third or fourth scanline may be used to generate or correct information on a first or second scanline, for example. In other words, during the second pass, “future” context may be used to improve the rendering of the image data because the image data was previously processed during the first pass.

During the first pass of a two pass method, pixels may be classified, tagged according to image type, and both the image video and classification tag stored. Such tags and image video may analyzed and the results used to associate pixels into larger windows. Statistics on the image video and classification tags for these windows may be gathered for each window, as well as for the area outside of all windows. After the first pass finishes but before the second pass begins, software may read the window and non-window statistics and may use calculations and heuristic rules to classify the delineated areas of windows and non-windows. During the second pass, the results of this classification, as well as the pixel tag and image video from the first pass, may be used to control optimized processing of the image video.

Typically, windows within a document image are detected as areas separated by white areas of the document. Exemplary methods and apparatus for classifying image data are discussed in U.S. Pat. Nos. 5,850,474 and 6,240,205 to Fan et al., each of which is incorporated herein by reference in its entirety. Typically, such windowing methods depend heavily on the luminance and/or chrominance of the video to delineate the boundaries of the window.

### SUMMARY

Methods segmenting image data into one or more windows, may specify specialized downstream processing for each pixel in a window according to their image types. Objectionable artifacts may be erroneously generated during downstream processing if neighboring pixels are classified with image types calling for mutually incompatible downstream processing.

Exemplary methods and apparatus for auto windowing (“windowing”) may allow individual pixels within a window to receive specialized downstream processing according to their subtype while preventing objectionable artifacts. Such methods and apparatus for windowing image data may be incorporated in scanning devices and may include a first pass through the image data to identify windows and to initially label each of the pixels in a window as a particular image type. A second pass through the data may relabel pixels based upon statistics collected during the first pass.

To improve efficiency, window labels, or IDs, may be allocated on an ongoing basis during, for example, first-pass processing, while at the same time dynamically compiling window ID equivalence information. Once the image type for each window is known, further processing of the image data may be more optimally specified and performed.

Exemplary embodiments may automatically locate a window contained within a document. A window is defined herein as any non-background area, such as a photograph or halftone picture, but may also include text, background noise and white regions. Various embodiments described herein include two passes through the image data.

During a first pass through the imaged data, a classification module may classify pixels may as white, black, edge, edge-in-halftone, continuous tone (rough or smooth), and halftones over a range of frequencies. Concurrently, a window detection module may generate window-mask data, may collect window statistics, and may develop an ID equivalence table, all to separate the desired windows from undesired regions.

Windowing may be accomplished by identifying and keeping track of pixels labeled as “background” vs. “non-background” and by combining image-run sections of scanlines to form windows. Statistics on pixel classification within each window may then compiled and examined.

Known first pass window operation methods may be used to accomplish these functions, including the methods described in the aforementioned Fan references, the entire disclosures of which are hereby incorporated by reference.

During a second pass through the image data, pixel tags may be modified by a retagging module, replacing each pixel's first-pass tag with a new tag indicating association with a window. These tags may be later used to control downstream processing or interpretation of the image.

For windows containing predominantly a single image type, there will invariably be pixels within such windows that are different in some important way, even though they are structurally part of the single window. Differences, for example, may include strong local video gradient (i.e., edges), proximity to the edge of the window, or a difference in color neutrality. Uniform re-labeling, while enabling the window as a whole to be recognized and processed, may preclude these special pixels from receiving the special processing they require.

Exemplary embodiments of a windowing method and apparatus disclosed herein may include assigning a subtype, from a sub-class of image types, to a pixel, the subtype indicating membership in a window and also indicating a more specialized sub-class of image types. Membership in the sub-class may specify downstream processing specific to the subtype and compatible with the downstream processing of other subtypes within the sub-class. Such methods and apparatus may allow individual pixels within a window to receive specialized downstream processing according to their subtype while preventing objectionable artifacts.

Such windowing apparatus and methods disclosed herein may be incorporated in an imaging device, such as a xerographic imaging system. In such a system, the apparatus and methods for subtyping window elements in a document may process input data and a marking engine of the xerographic imaging system may provide the output work product.

### BRIEF DESCRIPTION OF THE DRAWINGS

Various exemplary embodiments are described in detail, with reference to the following figures, wherein:

FIG. 1 shows a flowchart illustrating an exemplary two pass windowing method.

FIG. 2 shows a block diagram of an exemplary two pass windowing apparatus.

### DETAILED DESCRIPTION OF EMBODIMENTS

The following detailed description of exemplary embodiments is particularly directed to re-labeling pixels within a window with one of a set of tags, each member in the set indicating membership in the larger window and also indicating membership in a more specialized subclass, making downstream processing aware of the special characteristics.

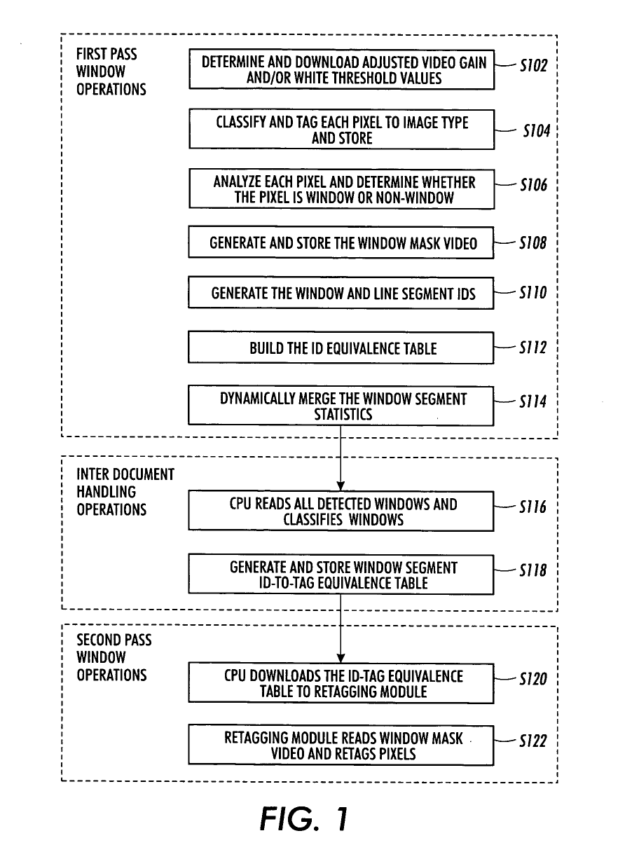

The exemplary apparatus and methods herein described may be incorporated within image scanners and may include two passes through the image data. FIG. 1 is a flowchart illustrating an exemplary two pass windowing method.

The exemplary method classifies each pixel as a particular image type, separates a page of image data into windows and background, collects document statistics on window areas, non-window areas and pixel image type and retags pixels appropriately based upon the collected statistics. Once the image type for each window is known, rendering, or other processing modules, not shown, may process the image data and do so more optimally than if the windowing and retagging were not performed.

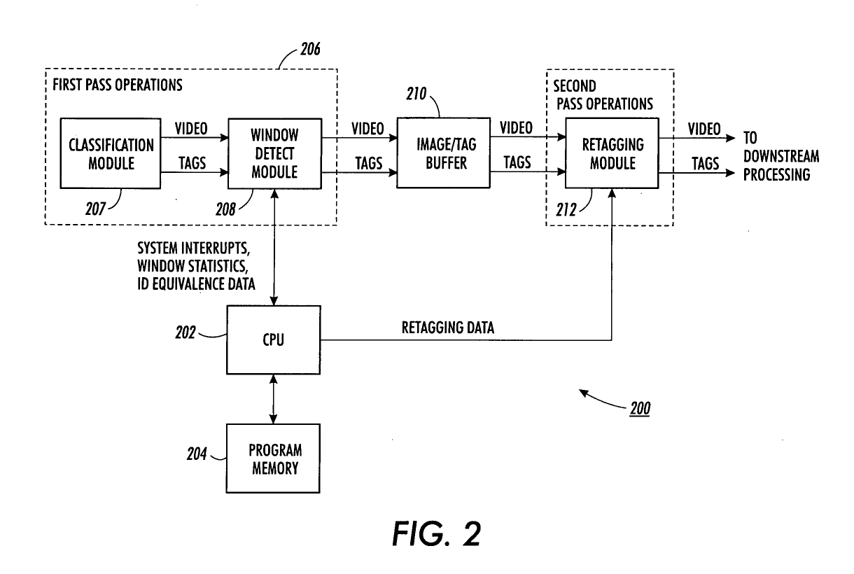

A block diagram of an exemplary two pass windowing system 200 that may carry out the exemplary method is shown in FIG. 2. The exemplary system 200 may include a central processing unit (CPU) 202 in communication with a program memory 204, a first pass operations module 206 including a classification module 207 and a window detection module 208, a RAM image buffer 210 and a retagging module 212. The CPU 202 may transmit and/or receive system interrupts, statistics, ID equivalence data and other data to/from the window detection module 208 and may transmit pixel retagging data to the retagging module 212. The first pass and second pass operations may be implemented in a variety of different hardware and software configurations, and the exemplary arrangement shown is non-limiting.

During the first pass through the image data, pixels may be classified by the classification module 207 into, for example, white, black, edge, edge in halftone, continuous tone, and halftones over a range of frequencies. Segmentation tags, edge strength tags and video may be sent to the window detection module 208, which may use such tags and video to associate pixels with various windows and calculate various statistics for each window created.

Although default control parameters for background white threshold and background gain may be used initially, once sufficient statistics are collected, subsequent values may be determined and downloaded by the CPU 202, in step S102, to the window detection module 208. Using such subsequent values may improve the determination of whether a pixel is part of a window or is background. A detailed description of such control parameters is provided below.

As the image is scanned and stored, each pixel may, in step S104, be classified and tagged by the classification module 207 as being of a specific image type. In the exemplary embodiment shown in FIG. 1, the tags may also be stored. Alternatively, however, the tags may not be stored for later use, instead, they may be recreated at the beginning of the second pass. In addition, step S104 may be performed concurrently with step S102. The order of the steps shown in FIG. 1 is exemplary only and is non-limiting.

An exemplary approach to pixel classification may include comparing the intensity of a pixel to the intensity of its surrounding neighboring pixels. A judgment may then be made as to whether the intensity of the pixel under examination is significantly different than the intensity of the surrounding pixels. When a pixel has a significantly high luminance, the pixel may be classified as a background pixel. However, as discussed below, pixels adjacent to window objects may be uncertain in this regard.

Subsequent to pixel classification, the window detection module 208 may, in step S106, analyze each pixel and may determine whether the pixel is window or background. Exemplary methods described herein may better define an outline around window objects by using at least one control parameter specific to determining whether pixels belong to window or background areas. Such control parameters may include a background gain parameter and/or a background white threshold parameter that may be predetermined or calculated and may be distinct from other gain and/or white threshold levels used by the classification step S104 to classify a “white” pixel with a white tag.

In step S108, a window mask may be generated as the document is scanned and stored into image/tag buffer 210. The scanned image data may comprise multiple scanlines of pixel image data, each scanline typically including intensity information for each pixel within the scanline, and, if color, chroma information. Typical image types include graphics, text, white, black, edge, edge in halftone, continuous tone (rough or smooth), and halftones over a range of frequencies.

During step, S110, performed by the classification module 207, window and line segment IDs may be allocated as new widow segments are encountered. For example, both video and pixel tags may be used to identify those pixels within each scanline that are background and those pixels that belong to image-runs. The image type of each image run may then be determined based on the image type of the individual pixels. Such labels, or IDs, may be monotonically allocated as the image is processed.

In step S112, the window detection module 208 may dynamically compile window ID equivalence information and store such data in an ID equivalent table, for example.

Also in step S112, decisions are made to discard windows and their associated statistics which have been completed without meeting minimum window requirements.

In step S114, at the end of the first pass, an ID equivalence table and the collected statistics may be analyzed and processed by the window detection module 208. When processing is completed, the window detection module 208 may interrupt the CPU 202 to indicate that all the data is ready to be retrieved.

Typically, while a document image is initially scanned, the windowing apparatus performs its first pass through the document image. In order to optimize processing speed, a subsequent image may be scanned and undergo first pass windowing operations concurrent with the second pass of the first image. However, after the first pass operations finish, but before the second pass begins, inter-document handling may be performed by the CPU 202.

In step S116, the CPU may read the statistics of all windows that have been kept and apply heuristic rules to classify the windows. Windows may be classified as one of various image types, or combinations of image types.

In addition, between the first and second pass operations, the CPU 202 may generate and store, in step S118, a window segment ID-to-Tag equivalence table.

During a second pass, pixels may be tagged by the retagging module 212. In step S120, the CPU 202 may download retagging data comprising the window segment ID-to-Tag equivalence table to the retagging module 212. In step S122, the retagging module 212 may read the window mask from the image buffer 210 and may retag pixels within all selected windows with an appropriate uniform tag based upon the ID-to-Tag equivalence table.

Once each portion of the image data has been classified according to image types, further processing of the image data may be performed more optimally.

Referring back to the first pass operations, pixel tags and window IDs may be allocated without too much regard for how a individual pixel may be processed downstream as compared to a neighboring pixel within the same window. Adjacent pixels with incompatible image types may call for specialized processing which may result in objectionable artifacts being generated during the rendering process. Such artifacts may detract from image quality. Relabeling all pixels within a window with the same image type may reduce this problem, but may still provide less than optimal image quality.

Exemplary methods may include assigning a subtype, from a sub-class of image types, to a pixel, the subtype indicating membership in a window and also indicating a more specialized sub-class of image types. Membership in the sub-class specifies downstream processing specific to the subtype while being compatible with the downstream processing of other subtypes within the sub-class.

At the end of the first pass, or in between passes, collected window statistics may be analyzed to develop a set of mutually compatible subtypes suitable for use by downstream processing, given the overall window type and the specialized characteristics of the pixels associated with the window. During the second pass, each pixel associated with the window may be relabeled with an appropriate subtype of image types developed for the window, enabling each pixel to be processed by downstream processing in a manner which is compatible with that of other pixels associated with the window.

For example, such windowing embodiments disclosed herein may be incorporated in an imaging device, such as a xerographic imaging system. In such a system, the apparatus and methods for detecting white areas within windows may provide the document input portion and a marking engine within the xerographic imaging system may provides the work product output.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art and are also intended to be encompassed by the following claims.

What is claimed is:

1. A windowing method, comprising:
subtyping pixels within a window, a subtype indicating membership in a window and also indicating a more specialized sub-class of image types.

2. The method according to claim 1, wherein subtyping pixels further comprises:
defining at least one subtype within a sub-class of image types, the subtype indicating membership in a window and also indicating a more specialized sub-class of image types; and
labeling pixels within a window with a subtype from a sub-class of image types, the sub-class being associated with all pixels within the window.

3. The method according to claim 1, wherein membership in the more specialized sub-class of image types specifies a downstream processing which is specific to the subtype while being compatible with the downstream processing of other subtypes within the sub-class.

4. The method according to claim 1, further comprising preventing the creation of objectionable artifacts by the use of subtyping.

5. An apparatus that performs a window pixel subtyping operation, the apparatus comprising at least one logic module, the at least one logic module being configured:
to define at least one subtype within a sub-class of image types, the subtype indicating membership in a window and also indicating a more specialized sub-class of image types; and
to label pixels within a window with a subtype from a sub-class of image types, the sub-class being associated with all pixels within the window.

6. The apparatus according to claim 5, wherein the at least one subtype indicates specialized, downstream processing compatible with other subtypes of the window image type.

7. A xerographic imaging device comprising the apparatus of claim 5.

8. A method of subtyping pixels in at least one window, comprising a first pass through image data, the first pass including:
classifying and tagging each pixel with an image type; and
collecting window statistics; and
a second pass through the image data, the second pass including:
labeling each pixel within a window with an image subtype;
wherein pixels labeled with a subtype indicate membership in a window and also indicate a more specialized sub-class of image types.

9. The method according to claim 8, further comprising preventing the creation of objectionable artifacts by the use of subtypes to drive compatible downstream processing for neighboring pixels.
